(19) United States
(12) Patent Application Publication
(10) Pub. No.: US 2009/0063392 A1
(43) Pub. Date: Mar. 5, 2009

(54) ADAPTIVE ANALYSIS TECHNIQUES FOR ENHANCING TRAIN STATIONS PLACEMENTS

(76) Inventor: Menachem Levanoni, Poway, CA (US)

Correspondence Address: Stephen C. Kaufman;IBM CORPORATION, Intellectual Property Law Dept., P.O. Box 218, Yorktown Heights, NY, 10598, US

(21) Appl. No.: 11/849,404

(22) Filed: Sep. 4, 2007

(51) Int. Cl. G06F 7/00

(52) U.S. Cl. 707/1; 707/E17.001

(57) ABSTRACT

A computer method for enhancing train stations locations. The method includes the steps of providing a demand database comprising a compendium of individual demand history; providing a train stations database comprising a compendium of at least one of train stations locations solutions, train stations information, and train stations diagnostics; and, employing a adaptive analysis technique for interrogating the demand and train stations databases for generating an output data stream, the output data stream correlating demand problem with train stations placement solution.

### BACKGROUND OF THE INVENTION

1. Field of the Invention

This invention relates to methodology for utilizing adaptive analysis techniques in the area of train stations placements.

2. Introduction to the Invention

Adaptive analysis techniques are known and include disparate technologies, like neural networks, which can work to an end of efficiently discovering valuable, non-obvious information from a large collection of data. The data, in turn, may arise in fields ranging from e.g., marketing, finance, manufacturing, or retail.

### SUMMARY OF THE INVENTION

We have now discovered novel methodology for exploiting the advantages inherent generally in adaptive analysis technologies, in the particular field of train stations placements applications.

Our work proceeds in the following way.

Normally, a train stations manager develops a demand database comprising a compendium of individual demand history—e.g., the demand's correlation to geographical locations. Secondly, and independently, the train stations manager develops in his mind a distribution database comprising the train stations manager's personal, partial, and subjective knowledge of objective retail facts culled from e.g., the marketing literature, the business literature, or input from colleagues or salespersons. Thirdly, the train stations manager subjectively correlates in his mind the necessarily incomplete and partial train stations database, with the demand database, in order to promulgate an individual's demand's prescribed train stations placements evaluation and selection.

This approach is part science and part art, and captures one aspect of the problems associated with train stations placement. However, as suggested above, it is manifestly a subjective paradigm, and therefore open to human vagaries.

We now disclose a novel computer method which can preserve the advantages inherent in the abovementioned approach, while minimizing the incompleteness and attendant subjectivities that otherwise inure in a technique heretofore entirely reserved for human realization.

To this end, in a first aspect of the present invention, we disclose a novel computer method comprising the steps of:
i) providing a demand database comprising a compendium of demand history;
ii) providing a train stations database comprising a compendium of at least one of train stations locations solutions, train stations information, and distribution diagnostics; and
iii) employing a adaptive analysis technique for interrogating said demand and train stations databases for generating an output data stream, said output data stream correlating demand problem with train stations locations solution.

The novel method preferably comprises a further step of updating the step i) demand database, so that it can cumulatively track the demand history as it develops over time. For example, this step i) of updating the demand database may include the results of employing the step iii) adaptive analysis technique. Also, the method may comprise a step of refining an employed adaptive analysis technique in cognizance of pattern changes embedded in each database as a consequence of distribution results and updating the demand database.

The novel method preferably comprises a further step of updating the step ii) train stations database, so that it can cumulatively track an ever increasing and developing technical train stations management literature. For example, this step ii) of updating the train stations database may include the effects of employing an adaptive analysis technique on the demand database. Also, the method may comprise a step of refining an employed adaptive analysis technique in cognizance of pattern changes embedded in each database as a consequence of train stations geography results and updating the train stations database.

The novel method may employ advantageously a wide array of step iii) adaptive analysis techniques for interrogating the demand and train stations database for generating an output data stream, which output data stream correlates demand problem with train stations locations solution. For example, the adaptive analysis technique may comprise inter alia employment of the following functions for producing output data: classification-neural, classification-tree, clustering-geographic, clustering-neural, factor analysis, or principal component analysis, or expert systems.

In a second aspect of the present invention, we disclose a program storage device readable by machine to perform method steps for providing an interactive train stations management database, the method comprising the steps of:
iv) providing a demand database comprising a compendium of individual demand history;
v) providing a train stations database comprising a compendium of at least one of train stations locations solutions, train stations information, and train stations diagnostics; and
vi) employing a adaptive analysis technique for interrogating said demand and train stations databases for generating an output data stream, said output data stream correlating demand problem with train stations locations solution.

In a third aspect of the present invention, we disclose a computer comprising:
i) means for inputting a demand database comprising a compendium of individual demand history;
ii) means for inputting a train stations database comprising a compendium of at least one of train stations locations solutions, train stations information, and train stations diagnostics;
iii) means for employing a adaptive analysis technique for interrogating said train stations databases; and
iv) means for generating an output data stream, said output data stream correlating demand problem with train stations locations solution.

### BRIEF DESCRIPTION OF THE DRAWING

The invention is illustrated in the accompanying drawing, in which

FIG. 1 provides an illustrative flowchart comprehending overall realization of the method of the present invention;

FIG. 2 provides an illustrative flowchart of details comprehended in the FIG. 1 flowchart;

FIG. 3 shows a neural network that may be used in realization of the FIGS. 1 and 2 adaptive analysis algorithm; and

FIG. 4 shows further illustrative refinements of the FIG. 3 neural network.

### DETAILED DESCRIPTION OF THE PRESENT INVENTION

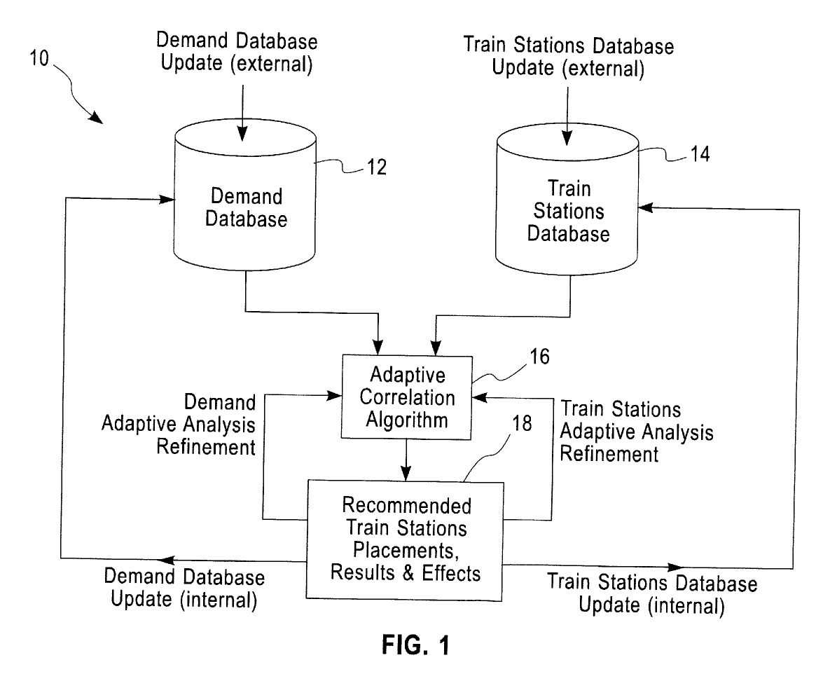

The detailed description of the present invention proceeds by tracing through three quintessential method steps, summarized above, that fairly capture the invention in all its sundry aspects. To this end, attention is directed to the flowcharts and neural networks of FIGS. 1 through 4, which can provide enablement of the three method steps.

FIG. 1, numerals 10-18, illustratively captures the overall spirit of the present invention. In particular, the FIG. 1 flowchart (10) shows a demand database (12) comprising a compendium of individual demand history, and a train stations database (14) comprising a compendium of at least one of train stations locations solutions, train stations information, and train stations diagnostics. Those skilled in the art will have no difficulty, having regard to their own knowledge and this disclosure, in creating or updating the databases (12,14) e.g., conventional techniques can be used to this end. FIG. 1 also shows the outputs of the demand database (12) and train stations database (14) input to a adaptive analysis condition algorithm box (16). The adaptive analysis algorithm can interrogate the information captured and/or updated in the demand and train stations databases (12,14), and can generate an output data stream (18) correlating demand problem with train stations locations solution. Note that the output (18) of the adaptive analysis algorithm can be most advantageously, self-reflexively, fed as a subsequent input to at least one of the demand database (12), the train stations database (14), and the adaptive analysis correlation algorithm (16).

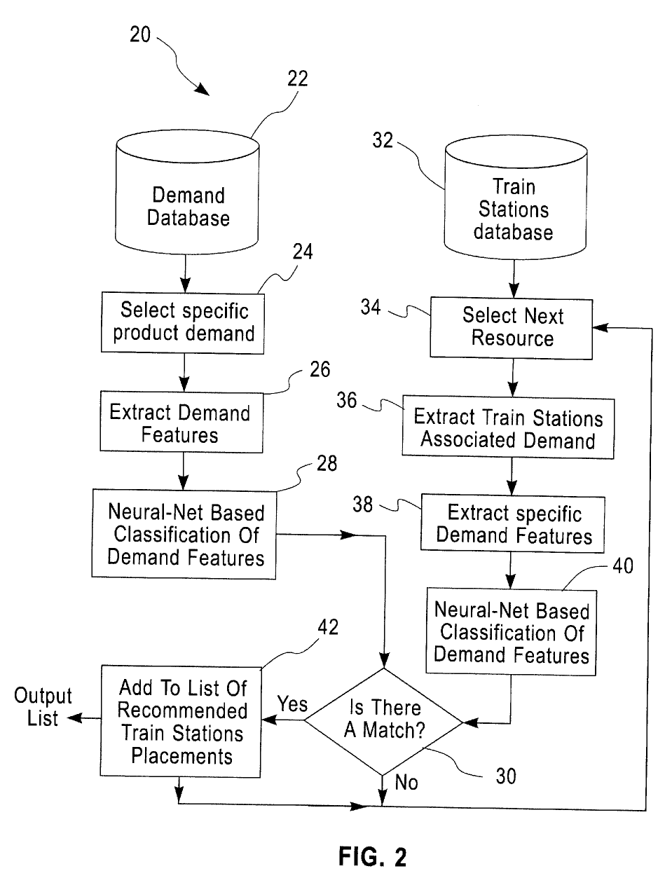

Attention is now directed to FIG. 2, which provides a flowchart (20-42) that recapitulates some of the FIG. 1 flowchart information, but adds particulars on the immediate correlation functionalities required of a adaptive analysis correlation algorithm. For illustrative purposes, FIG. 2 comprehends the adaptive analysis correlation algorithm as a neural-net based classification of demand features, e.g., wherein a demand feature may include location information such as geography, demographics, current local inventory, expected demand by week, etc.

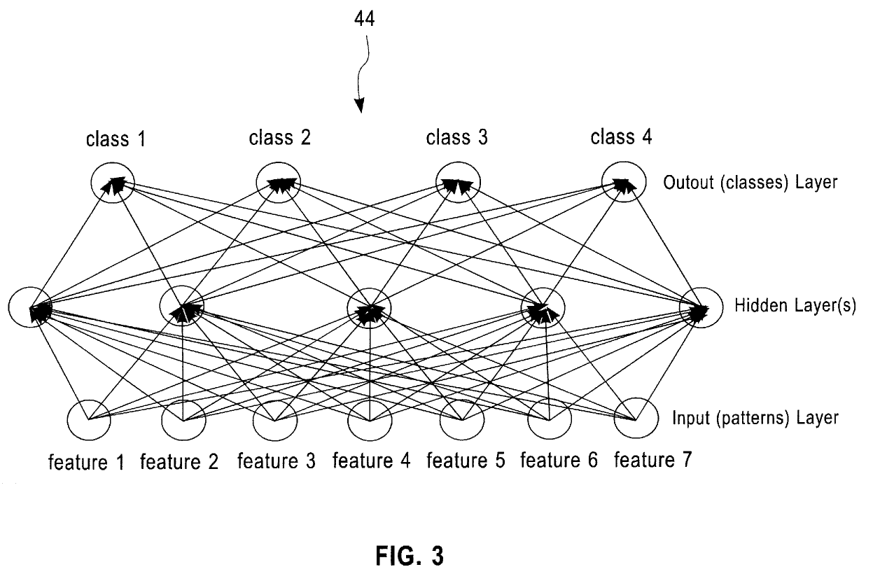

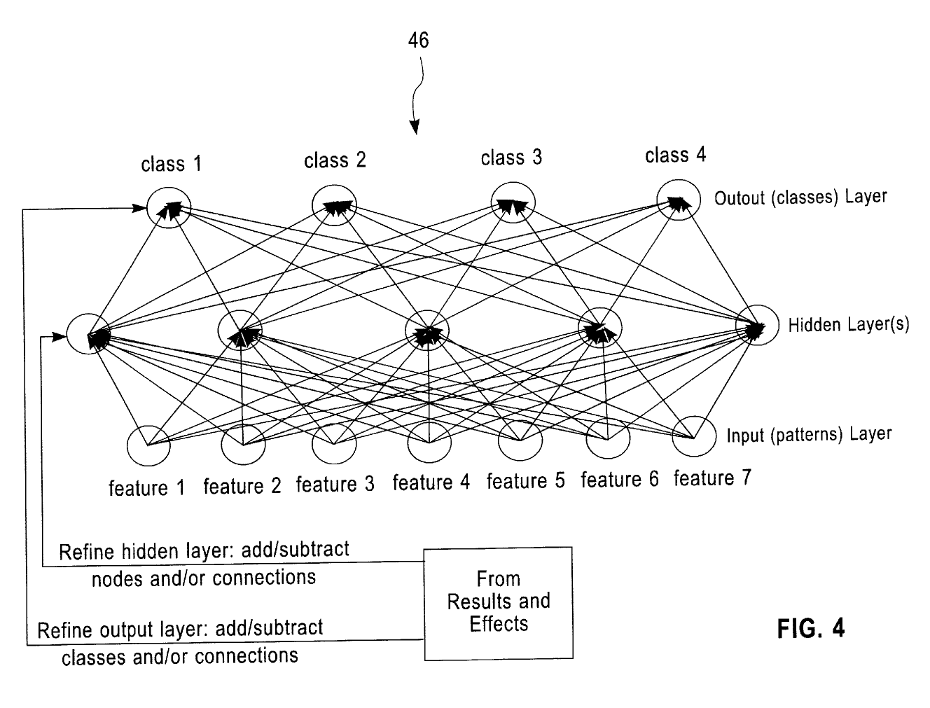

FIG. 3, in turn, shows a neural-net (44) that may be used in realization of the FIGS. 1 and 2 adaptive analysis correlation algorithm. Note the reference to classes which represent classification of input features. The FIG. 3 neural-net (44) in turn, may be advantageously refined, as shown in the FIG. 4 neural-net (46), to capture the self-reflexive capabilities of the present invention, as elaborated above.

What is claimed:

1. A computer method comprising the steps of:
i) providing a demand database comprising a compendium of individual demand history;
ii) providing a train stations database comprising a compendium of at least one of train stations locations solutions, train stations information, and train stations diagnostics; and
iii) employing a adaptive analysis technique for interrogating said demand and train stations databases for generating an output data stream, said output data stream correlating demand problem with train stations locations solution.

2. A method according to claim 1, comprising a step of updating the demand database.

3. A method according to claim 2, comprising a step of updating the demand database so that it includes the results of employing a adaptive analysis technique.

4. A method according to claim 1, comprising a step of updating the train stations database.

5. A method according to claim 4, comprising a step of updating the train stations database so that it includes the effects of employing a adaptive analysis technique on the demand database.

6. A method according to claim 2, comprising a step of refining a employed adaptive analysis technique in cognizance of pattern changes embedded in each database as a consequence of updating the demand database.

7. A method according to claim 4, comprising a step of refining a employed adaptive analysis technique in cognizance of pattern changes embedded in each database as a consequence of updating the train stations database.

8. A program storage device readable by machine, tangibly embodying a program of instructions executable by the machine to perform method steps for providing an interactive train stations management database, the method comprising the steps of:
i) providing a demand database comprising a compendium of individual demand history;
ii) providing a train stations database comprising a compendium of at least one of train stations placement solutions, train stations information, and train stations diagnostics; and
iii) employing a adaptive analysis technique for interrogating said demand and train stations databases for generating an output data stream, said output data stream correlating demand problem with train stations locations solution.

9. A computer comprising:
i) means for inputting a demand database comprising a compendium of individual demand history;
ii) means for inputting a train stations database comprising a compendium of at least one of train stations management solutions, train stations information, and train stations diagnostics;
iii) means for employing a adaptive analysis technique for interrogating said demand and train stations databases; and
iv) means for generating an output data stream, said output data stream correlating demand problem with train stations locations solution.
